(19) United States
(12) Patent Application Publication
(10) Pub. No.: US 2011/0317015 A1
(43) Pub. Date: Dec. 29, 2011

(54) VEHICLE-MOUNTED CAMERA MODULE

(75) Inventors: Hideyuki Seto, Tokyo (JP); Hidetoshi Umeda, Tokyo (JP); Takatoshi Nakata, Tokyo (JP)

(73) Assignee: KYOCERA CORPORATION, Kyoto (JP)

(21) Appl. No.: 13/129,562

(22) PCT Filed: Oct. 29, 2008
(86) PCT No.: PCT/JP2008/069639

§ 371 Date: Sep. 16, 2011

(51) Int. Cl. H04N 7/18

(52) U.S. Cl. 348/148; 348/E07.085

(57) ABSTRACT

A vehicle-mounted camera module that is provided inside of the vehicle and used for surveying the inside and outside of the vehicle, the camera module including, but not limited to: an image sensor; an inside view optical system for picking up vehicle inside views; and an outside view optical system for picking up vehicle outside views, the outside view optical system including a light reflector.

### BACKGROUND OF THE INVENTION

1. Field of the Invention

The present invention relates to a vehicle-mounted (or a car installed) camera module; whereby; in particular, the camera module is preferably used for performing image sensing by use of one image sensing device so that the condition of the driver inside of the vehicle as well as the view on the front side outside of the vehicle is surveyed; the camera module is preferably used for detecting the dozing or looking-away motion of the driver based on the conditions regarding the running vehicle as well as regarding the sitting driver so that an alarm is issued to prevent an accident; the camera module is preferably used for detecting the distance between the driver's vehicle and the one ahead as well as detecting the object coming rushing into the driving course of the vehicle so that an alarm is issued to prevent an accident; the camera module is preferably used for being served as a drive recorder (i.e. an event recorder) so that the images detected by the camera module can be used as an evidence of the conditions regarding the driver, the vehicle and the road, in a case of an accident.

2. Background of the Invention

Patent Reference 1, for instance, discloses a camera module that is used for picking up the images inside as well as outside of a vehicle, for detecting the dozing or looking-away motion of the driver of the vehicle so that an alarm is issued to prevent an accident, for detecting the distance between the driver's vehicle and the one ahead as well as detecting the object coming rushing into the driving course of the vehicle so that an alarm is issued to prevent an accident, and for being served as a drive recorder (i.e. an event recorder) so that the images detected by the camera module can be used as an evidence of the conditions regarding the driver, the vehicle and the road, in a case of an accident.

The vehicle surveillance unit and the room mirror device that are disclosed in Patent Reference 1 include a front side surveillance camera provided at the room mirror device, a vehicle inside surveillance camera, and an image storage device storing the images picked up by these surveillance cameras; whereby, the front side surveillance camera is changed to the ON state by a control section (or part) when a driver gets into the vehicle; the vehicle inside surveillance camera is changed to the ON state in response to the movement of the image picked up by the front side surveillance camera when the vehicle begins moving. The vehicle inside surveillance camera picks up the images regarding the face of the driver as well as the views inside of the vehicle; if the vehicle surveillance unit recognizes that the face of driver is continuously in an upward-pointing or downward-pointing state for a predetermined duration of time, an alarm issuing section (or part) issues an alarm melody so as to prevent a potential drowsy-driver accident in the bud.

Further, Patent Reference 2 discloses an automatic surveillance device that surveys the circumference around a vehicle; whereby, a mirror (as a mirror of the side mirror device) is embedded in the vehicle rear side of the housing of the side mirror devices of the vehicle, and visible light passes through the embedded mirror and near-infrared light (rays) are reflected by the embedded mirror (at the both side surfaces of the embedded mirror); a camera that can pick up the images formed by the visible light and the near-infrared light is arranged on the back surface side of the housing of the side mirror device, whereby the visible light is launched toward the camera from the rear side of the vehicle after penetrating the embedded mirror and the near-infrared light are launched toward the camera from the front side of the vehicle after being reflected by the vehicle front side surface of the embedded mirror (cf. FIG. 3 in Patent Reference 2); namely, an opening (an aperture) is provided at the front side of the housing so that the near-infrared light from the vehicle front side enter the inside of the housing and are reflected by the inside surface of the embedded mirror (to reach the camera); incidentally, visible light from the vehicle front side (through the opening) passes through the embedded mirror, while visible light from the vehicle rear side penetrates the embedded mirror and reaches the camera. In this way, the images formed by the visible light reaching the camera and the near-infrared light reaching the camera are picked up and are displayed by use of a monitor provided inside of the vehicle.

Further, there is another surveillance device that is provided with an omni-directional camera that is a camera with a 360-degree field of view in the horizontal plane, or with a visual field that covers (approximately) the entire sphere; thereby, the camera is arranged so that the field of view of the camera includes the images of the vehicle driver; further, the image signals picked-up by the camera or the optical device can be recorded, and the signals can be outputted into an external device as needed; and, in case of an accident, the surveillance device can make it possible to objectively analyzes the cause of the accident and the damage.

### REFERENCES

### Patent References

Patent Reference 1: JP2006-193057
Patent Reference 2: JP2007-50749

### SUMMARY OF THE INVENTION

### Subjects to be Solved

Even with the disclosed technologies as quoted above, there still remain insufficiencies or difficulties in the conventional technologies. According to the vehicle surveillance unit and the room mirror device that are disclosed in Patent Reference 1, two types of cameras, namely, the front side surveillance camera and the vehicle inside surveillance camera are used. Thus, the cost of the surveillance unit is increased. Further, the automatic surveillance device that is disclosed in Patent Reference 2 can only survey the outside of the vehicle; moreover, the image that the camera picks up includes the image of the vehicle front side view and the image of the vehicle rear side view and the superposed image is not seen well, the image superposing being attributable to the structure of the automatic surveillance device. In addition, according to the method in which the omni-directional camera with a 360-degree field of view is used and arranged so that the field of view of the camera includes the images of the vehicle driver, a camera of an omni-directional type or a spherical lens is needed; the outward appearance of the surveillance device includes the appearance regarding the part of the spherical lens; thus, the beauty of the vehicle inside scenery may be spoiled. Moreover, since the spherical lens is used, the picked-up image may be distorted; accordingly, the distorted images must be corrected. When the distortion correction is performed, the corrected image may be blurred; as a result, for instance, in picking up the image of the driver's eyes or the road's warning line as well as in judging whether or not the driver is dozing or the vehicle is driven in a zigzag line, apt decision may not be made.

In view of the above-described difficulties in the conventional technologies, the present invention aims at providing a vehicle-mounted camera module without introducing complicated image processing steps as well as without increasing the cost thereof; whereby, the camera module can be used for detecting the dozing or looking-away motion of the driver based on the conditions regarding the running vehicle as well as regarding the driver inside of the vehicle so that an alarm is issued to prevent an accident; the camera module can be used for detecting the distance between the driver's vehicle and the one ahead as well as detecting the object coming rushing into the driving course of the vehicle so that an alarm is issued to prevent an accident; the camera module can be used for being served as a drive recorder so that the images detected by the camera module can be used as an evidence of the conditions regarding the driver, the vehicle and the road, in case of an accident.

### Means to Solve the Subjects

In order to reach the goals of the present invention, this specification discloses a vehicle-mounted camera module that is provided inside of the vehicle and surveys views of the inside and outside of the vehicle, the module including, but not limited to:
an image sensor;
an inside view optical system for forming images of vehicle inside views on the image sensor;
an outside view optical system for forming images of vehicle outside views of the vehicle front side on the image sensor;
at least one light reflector for reflecting the light that reaches the reflector through at least one of the inside view optical system and the outside view optical system, toward the image sensor.

With the configuration of the vehicle-mounted camera module as described above, it becomes possible to pick up both of the vehicle inside views and the vehicle outside views of the vehicle front side, even in a case where the camera module has only one image sensor to restrain the cost of the product. Moreover, by use of the vehicle-mounted camera module according the above configuration, it becomes possible detecting the dozing or looking-away motion of the driver based on the conditions regarding the running vehicle as well as regarding the driver,
detecting the distance between the driver's vehicle and the one ahead,
recognizing the condition that the distance is too short, and
detecting the object coming rushing into the driving course of the vehicle.

In this way, danger detection is performed as described above; further, an alarm can be issued so as to inform the driver of the danger; and, the camera module can be served as a drive recorder so that the images detected by the camera module can be used as an evidence of the conditions regarding the driver, the vehicle and the road, in case of an accident.

A preferable embodiment of the above is the vehicle-mounted camera module, wherein the image sensor has a first image forming area on which the images are formed by the light passing through the inside view optical system and a second image forming area on which the images are formed by the light passing through the outside view optical system, the two areas including no overlapping area that is common to the two areas.

As described above, the vehicle-mounted camera module includes no mechanically-moving parts; however, the images of the vehicle inside as well as the vehicle outside are picked up at the same time; further, the picked-up images can be displayed on display devices or memorized in picture recording devices so that the usefulness of the picked-up images themselves can be enhanced in using the picked-up images for detecting danger or providing evidence in case of an accident.

Another preferable embodiment is the vehicle-mounted camera module, wherein the inside view optical system has a first shutter and the outside view optical system has a second shutter thereby the first shutter is opened so that images are formed on the image sensor, when the second shutter is closed, whereas the second shutter is opened so that images are formed on the image sensor, when the first shutter is closed, the shutters being operated by a shutter control section provided in the vehicle-mounted camera module.

According to the above, the images of the vehicle inside can be changed to the images of the vehicle outside or vice versa, on the whole image forming area of the image sensor; the images can be displayed or recorded thereby the images of the vehicle inside as well as the vehicle outside can be widely taken-in in comparison with the case where the images are formed on the separated and limited area on the image sensor; or, the detail of the image can be displayed or recorded.

Another preferable embodiment is the vehicle-mounted camera module, wherein the light reflector is configured with a plurality of mirrors thereby the light reflecting angle regarding each mirror can be electrically controlled.

According to the above, for example, the images of the vehicle inside can be changed to the images of the vehicle outside or vice versa, even when the camera module is not provided with mechanically operated parts such as a shutter or a mechanically driven mirror that can change the reflecting light angle of incident light. Further, by changing the light reflecting angle of each of the multiple mirrors, wider view can be taken in without increasing the number of the pixels of the image sensor.

Another preferable embodiment is the vehicle-mounted camera module, the camera module further including, but not limited to, an abnormal event detecting section that detects an abnormal event based on the vehicle inside image information obtained via the inside view optical system as well as the vehicle outside image information obtained via the outside view optical system, and issues alarm signals.

According to the above, it becomes possible
detecting the dozing or looking-away motion of the driver based on the conditions regarding the running vehicle as well as regarding the driver,
detecting the distance between the driver's vehicle and the one ahead,
recognizing the condition that the distance is too short, and
detecting the object coming rushing into the driving course of the vehicle.

In this way, danger detection is performed as described above; further, an alarm can be issued so as to inform the driver of the danger.

Another preferable embodiment is the vehicle-mounted camera module, the camera module further including, but not limited to, an image recording section that memorizes the image information picked up by the image sensor.

According to the above, the images detected by the camera module can be used as an evidence of the conditions regarding the driver, the vehicle and the road, in case of an accident.

Another preferable embodiment is the vehicle-mounted camera module, wherein the camera module is installed in the room mirror inside of the vehicle.

According to the above, the camera module can be installed inside of the vehicle without hindering the driver from driving, without spoiling the beauty inside of the vehicle, and without particularly arranging an installation location for the vehicle-mounted camera module according to the present invention.

### Effects of the Invention

As described thus far, the vehicle-mounted camera module according to the present invention includes only one image sensor to restrain the cost of the product; however, the images regarding both of the vehicle inside and the vehicle outside can be picked up by means of the camera module; further it becomes possible detecting the dozing or looking-away motion of the driver based on the conditions regarding the running vehicle as well as regarding the driver, detecting the distance between the driver's vehicle and the one ahead, recognizing the condition that the distance is too short, and detecting the object coming rushing into the driving course of the vehicle. In this way, the vehicle-mounted camera module according to the present invention serves many useful functions.

### BRIEF DESCRIPTION OF THE DRAWINGS

The present invention will now be described in greater detail with reference to the preferred embodiments of the invention and the accompanying drawings, wherein:

FIG. 1(A) shows the outline arrangement of the vehicle inside where a room-mirror in which the vehicle-mounted camera module according to the present invention is incorporated is arranged;

FIG. 1(B) shows the outline regarding the inside of the room mirror into which the vehicle-mounted camera module is incorporated as well as regarding the optical paths toward the image sensor, the optical paths being an optical path from the vehicle front side as well as an optical path from the driver's eyes;

FIG. 2 shows a flow chart for detecting dangerous conditions by use of the vehicle-mounted camera module according to the present invention;

FIG. 3(A) shows a flow chart for detecting dangerous conditions with regard to the image recognition as to the warning line on the road, the flow chart being the detail of the step S12 in FIG. 2;

FIG. 3(B) shows, in a similar way, a flow chart for detecting dangerous conditions with regard to the image recognition as to the eyes of the driver 52, the flow chart being the detail of the step S13 in FIG. 2;

FIG. 4 shows the outline configuration of a first embodiment regarding the vehicle-mounted camera module according to the present invention;

FIG. 5 shows the explanatory block diagram regarding the first embodiment of the vehicle-mounted camera module according to the present invention;

FIG. 6 shows the outline configuration of a second embodiment regarding the vehicle-mounted camera module according to the present invention;

FIGS. 7(A) and 7(B) show the explanatory block diagrams regarding the second embodiment of the vehicle-mounted camera module according to the present invention, in a case where the camera module picks up the images of the vehicle inside view and the vehicle outside view in turn; thereby, the diagram of FIG. 7(A) is used when the vehicle-mounted camera module picks up the images of the vehicle inside view, and the diagram of FIG. 7(B) is used when the vehicle-mounted camera module picks up the images of the vehicle outside view;

FIG. 8(A) shows a flow chart regarding the second embodiment of the vehicle-mounted camera module according to the present invention, the flow chart being expressed in a time-sharing manner;

FIG. 8(B) shows the timing chart in response to FIG. 8(A);

FIG. 9 shows the outline configuration of a third embodiment regarding the vehicle-mounted camera module according to the present invention;

FIG. 10 shows the block diagram regarding the third embodiment of the vehicle-mounted camera module according to the present invention, thereby diagram explains the operations among the components in the vehicle-mounted camera module that includes the control section as a component, in a case where the upper area of the image sensor picks up the images of the vehicle inside view and the lower area of the image sensor picks up the images of the vehicle outside view in a wide range in chronological order;

FIG. 11(A) shows a flow chart regarding the third embodiment of the vehicle-mounted camera module according to the present invention, the flow chart being used in a case where the images of the vehicle outside view in a wide range are picked up in chronological order;

FIG. 11(B) shows the timing chart in response to FIG. 11(A);

FIG. 12 shows the outline configuration of a fourth embodiment regarding the vehicle-mounted camera module according to the present invention, thereby the camera module picks up the images of the vehicle inside view and the vehicle outside view in turn, by use of a DMD (Digital Micro-mirror Device);

FIGS. 13(A) and 13(B) show the explanatory block diagrams regarding the fourth embodiment of the vehicle-mounted camera module according to the present invention, in a case where the camera module picks up the images of the vehicle inside view and the vehicle outside view in turn in a time-sharing manner, thereby diagram explains the operations among the components in the vehicle-mounted camera module that includes the control section as a component; the diagram of FIG. 13(A) is used when the vehicle-mounted camera module picks up the images of the vehicle inside view, and the diagram of FIG. 13(B) is used when the vehicle-mounted camera module picks up the images of the vehicle outside view;

FIG. 14 (the upper part thereof) shows a flow chart regarding the second embodiment of the vehicle-mounted camera module according to the present invention, the flowchart being expressed in a time-sharing manner;

FIG. 14 (the lower part thereof) shows the timing chart in response to the upper part of FIG. 14.

### DETAILED DESCRIPTION OF THE PREFERRED EMBODIMENTS

Hereafter, the present invention will be described in detail with reference to the embodiments shown in the figures. However, the dimensions, materials, shape, the relative placement and so on of a component described in these embodiments shall not be construed as limiting the scope of the invention thereto, unless especially specific mention is made.

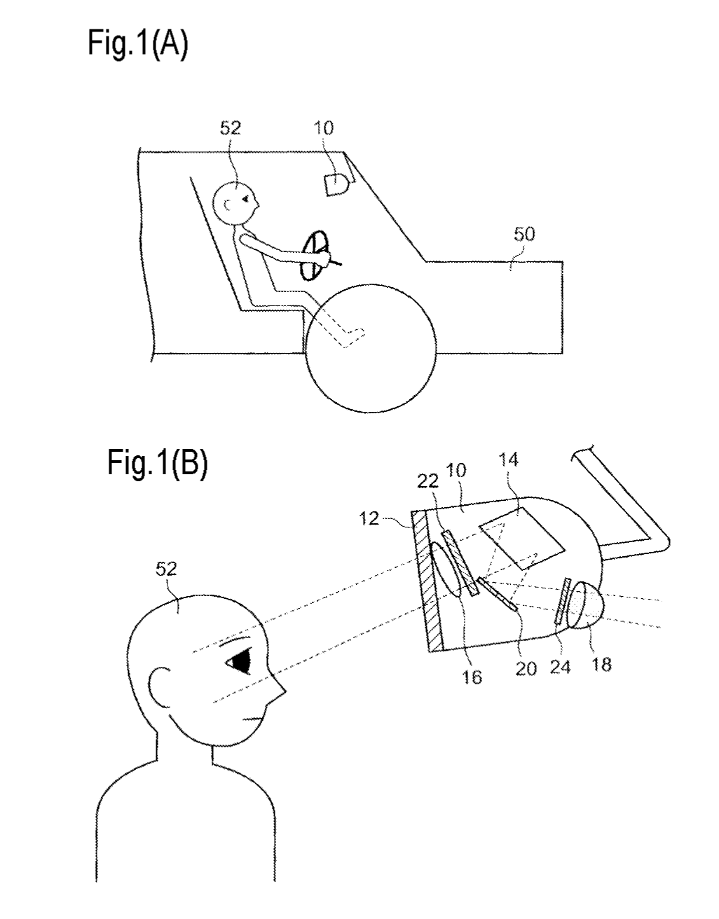

FIG. 1(A) shows the outline arrangement of the vehicle inside where a room mirror 10 in which the vehicle-mounted camera module according to the present invention is incorporated is arranged; FIG. 1(B) shows the outline regarding the inside of the room mirror 10 into which the vehicle-mounted camera module is incorporated as well as regarding the optical paths toward the image sensor, the optical paths being an optical path from the vehicle front side as well as an optical path from the driver's eyes.

As shown in FIG. 1(A), the vehicle-mounted camera module according to the present invention is incorporated into a mirror such as the room mirror 10 with which the driver 52 of a car 50 confirms the rear view. It is hereby noted that the vehicle-mounted camera module according to the present invention may be incorporated into, for instance, a mirror device provided in a car for female cosmetic use, the mirror device being fitted to a car inside part such as the sunshade visor. Recently, some cars are provided with such mirror devices; the vehicle-mounted camera module according to the present invention may be naturally incorporated into such mirror devices so long as the configuration of the camera module (as will be described later) can be incorporated into the mirror devices so that the images regarding the vehicle front side and the driver in the vehicle can be picked up, as well as, so long as the beauty of the car inside is not spoiled and an extra space is not required for incorporating the camera module. However, the explanation will be continued based on the premise that the vehicle-mounted camera module according to the present invention is incorporated into the room mirror.

Further, as shown in FIG. 1(B) that depicts the outline regarding the inside of the room mirror, in the vehicle-mounted camera module according to the present invention, a half mirror 12 is used for the mirror part of the room mirror 10 for confirming the rear view; in addition, the vehicle-mounted camera module indispensably includes an image sensor 14, an inside view optical system 16 for picking up vehicle inside views, an outside view optical system 18 for picking up vehicle outside views, and a light reflector 20 for reflecting the light from the vehicle front side toward the image sensor 14; in addition, the vehicle-mounted camera module, if necessary, includes an inside view shutter 22 for blocking the light from the vehicle inside and an outside view shutter 24 for blocking the light from the vehicle outside. In the above, the light reflector 20 is provided so as to reflect the light from the vehicle front side toward the image sensor 14; however, the light reflector 20 may be provided so as to reflect the light from the vehicle inside toward the image sensor 14; further, the light reflector 20 may be provided so as to reflect the light from the vehicle front side and the vehicle inside toward the image sensor 14, in response to each optical system 16 or 18.

Further, in this vehicle-mounted camera module, when the vehicle begins starting, one image sensor picks up not only the images formed by the light regarding the condition of the driver 52 the light which reaches the image sensor 14 through the half mirror 12 and the inside view optical system 16 but also the images formed by the light regarding the condition of the vehicle front side the light which reaches the image sensor 14 through the outside view optical system 18. Thereby, since there is no light source inside of the room mirror 10 in confirming the rear view, the room mirror 10 serves as an ordinary rear-view mirror when the driver confirms the rear views. When the image sensor forms the images of the views through the half mirror 12, the half mirror 12 serves as a sheet of transparent glass; thus, the mirror 12 is not an obstacle of the light path from the vehicle inside to the inside of the room mirror 10 through the mirror 12. Further, since the outside view optical system 18 is provided on the vehicle front side of the room mirror 10, the optical system 18 is not seen from the inside of the vehicle; as a result, the room mirror 10 does not spoil the beauty of the vehicle inside.

Further, there are a few approaches in forming images by use of the image sensor, as described later. In a first approach, on the upper area as well as the lower area of the image sensor, the images from the vehicle inside as well as the vehicle outside are separately formed on either of the areas at the same time; in another approach, the image sensor forms the images from the vehicle inside as well as the images from the vehicle outside in a time-sharing manner by use of the inside view shutter or the outside view shutter; in another approach, instead of the shutters, the light reflector which reflection angle can be electrically controlled is used so that, for instance, the view of the vehicle outside can be widely taken in; namely, without using the shutters, by changing-over the images of the vehicle inside to the images of the vehicle outside or vice versa, in a time-sharing manner, the images of the vehicle outside and the vehicle inside are formed on the image forming area of the image sensor in turn.

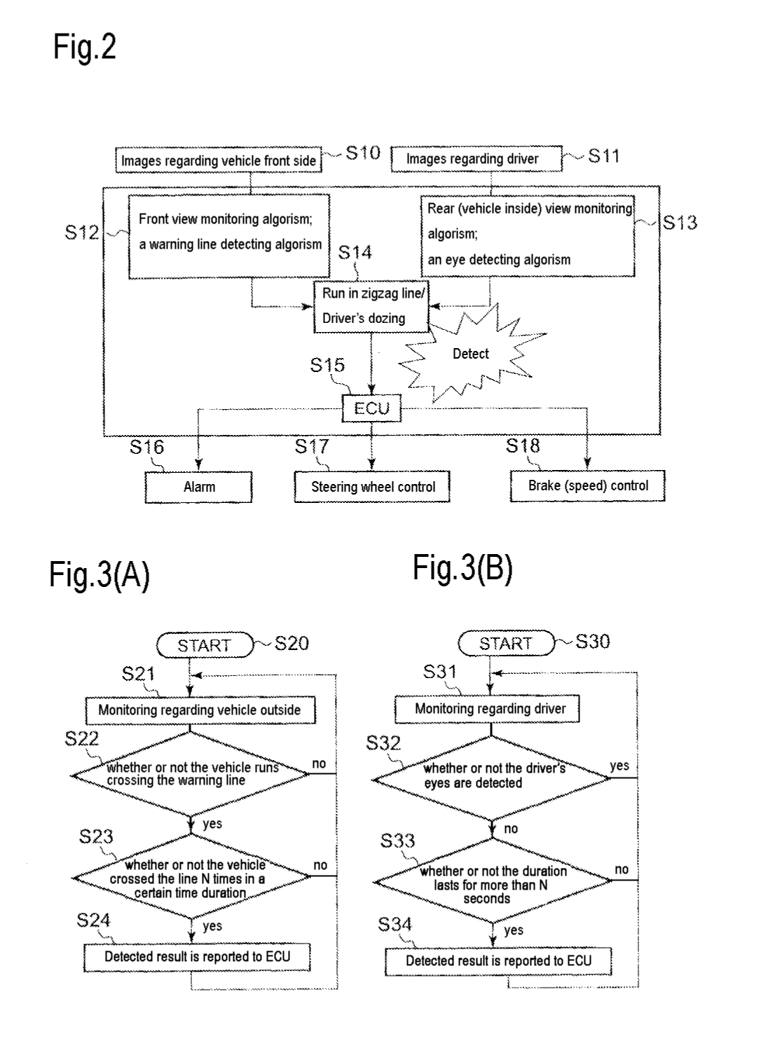

FIG. 2 shows a flow chart for detecting dangerous conditions by use of the vehicle-mounted camera module according to the present invention; FIG. 3(A) shows a flow chart for detecting dangerous conditions with regard to the image recognition as to the warning line on the road, the flow chart being the detail of the step S12 in FIG. 2; FIG. 3(B) shows, in a similar way, a flow chart for detecting dangerous conditions with regard to the image recognition as to the eyes of the driver 52, the flow chart being the detail of the step S13 in FIG. 2.

Firstly, in the step S10 in FIG. 2, by use of the outside view optical system 18 described in the above, the images regarding the vehicle front side view are formed; then, in the step S12 as will be explained later with FIG. 3(A), image recognition as to the warning line on the road of the vehicle front side is performed. Thereby,
if it is detected that the vehicle repeatedly crosses the warning line so that the vehicle runs in a zigzag line,
if it is especially judged, in the step S11 based on the formed images regarding the driver 52 detected by the inside view optical system, that the driver's eyes cannot be detected for a predetermined duration of time, even though the image recognition as to the driver's eyes is continuously performed, or
if it is judged, in the step S13 as will be explained later with, that the driver's face is directed toward an upper direction or a lower direction,
then it is recognized in the step S14 that the driver may be dozing or looking-away, and the recognition is transferred in the step S15 to the ECU (Electronic Control Unit) of the vehicle.

As described above, the image recognition regarding the warning line on the road as well as the judgment regarding the dangerous conditions is initiated when the processes of the step S20 start, the processes being described in the flow diagram of FIG. 3(A); in the following step S21, the views of the vehicle outside on the vehicle front side are surveyed so that the images of the warning line is recognized; when it is recognized in the following step S22 that the vehicle crosses the warning line as well as when it is judged in the step S23 that the vehicle runs in a zigzag line, if the warning line crossing frequencies becomes higher than or equal to a predetermined number N of times in a predetermined time span, for instance, 3 times in a certain time span, then the judgment that the vehicle is running in a zigzag line is reported to the ECU in the step S24.

Further, the image recognition regarding the eyes of the driver 52 is initiated when the processes of the step S30 start, the processes being described in the flow diagram of FIG. 3(B); in the following step S31, the driver 52 is watched by use of the images of the driver so that the eyes of the driver are monitored and the images of the eyes are recognized; if the eyes cannot be detected in the following step S32, it is judged in the step S33 that the driver may be dozing or looking-away, if the time span during which the eyes cannot be detected continues for a predetermined time span N (sec), for instance, 10 seconds, then the judgment that the driver is may be dozing or looking-away is reported to the ECU in the step S34. Incidentally, in recognizing the warning line or detecting the eyes, conventional methods regarding image recognition technique such as pattern matching (approach) can be used.

With reference to FIG. 2 again, when the ECU receives the report regarding the dangerous conditions that the vehicle may be running in a zigzag line, the eyes of the driver cannot be detected, or the driver may be dozing or looking-away, then
the ECU works at the step S15 so that alarms are issued in the step S16,
steering wheel control orders are issued in the step S17 so that the resistance in turning the steering wheels is increased to prevent the zigzag running, or
brake control orders are issued in the step S18 so that the vehicle speed is restrained to prevent an accident.

As described above, accidents caused by the dozing or looking-away conditions of the driver can be nipped in the bud; further, the vehicle-mounted camera module according to the present invention, for instance, makes it possible to recognize a vehicle running ahead of the driver's vehicle, to detect the distance between the driver's vehicle and the one ahead, to issue alarms or brake orders if the distance becomes excessively short, to detect an object coming rushing into the driving course of the vehicle, and to issue alarms or brake orders if the object coming rushing into the driving course is recognized, although no discussion has been made thus far. In this way, the vehicle-mounted camera module according to the present invention can be used so that potential accidents are nipped in the bud. Further, when the vehicle-mounted camera module according to the present invention is provided with an image recording section, then the images detected by the camera module can be used as an evidence of the conditions regarding the driver, the vehicle and the road, in case of an accident.

### First Embodiment

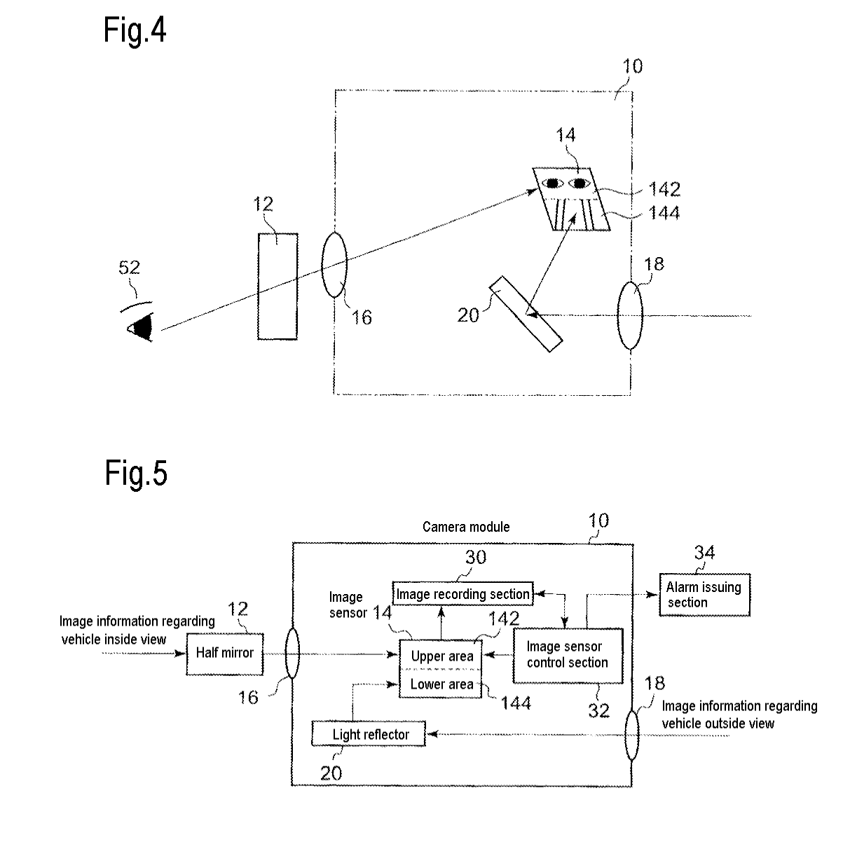

FIG. 4 shows the outline configuration of a first embodiment regarding the vehicle-mounted camera module according to the present invention explained thus far; with regard to this embodiment, FIG. 5 shows the explanatory block diagram. When the component in the following description is the same as a component in FIG. 1, the common number is used for the same components.

As shown in FIG. 4, the vehicle-mounted camera module according to the present invention includes, but not limited to: an image sensor 14; an upper area 142 of the image sensor whereby the images regarding the eyes of the driver 52 inside of the vehicle are picked up on the area 142; a lower area 144 of the image sensor whereby the images regarding the view outside of the vehicle are picked up on the area 144; an inside view optical system 16 for picking up vehicle inside views; an outside view optical system 18 for picking up vehicle outside views; and, a light reflector 20 for reflecting the light from the vehicle front side toward the image sensor 14. Hereby, in this embodiment, the upper area 142 of the image sensor 14 is used for monitoring the driver, while the lower area 144 of the image sensor 14 is used for picking up the images regarding the view outside of the vehicle. However, the upper area 142 may be used for picking up the outside images, while the lower area 144 of the image sensor 14 may be used for monitoring the driver. Further, the whole area of the image sensor 14 may be divided into a left area and a right area in a manner different from the manner of the attached drawings, so long as the area of the vehicle inside images is separated from the area of the vehicle inside images.

In the vehicle-mounted camera module according to this first embodiment, the whole area of the image sensor is divided into the area 142 on which the images are formed by the light through the inside view optical system 16 and the area 144 on which the images are formed by the light through outside view optical system 18. Thereby, the two areas 142 and 144 are demarcated so that there is no overlap. In this way, it becomes possible that the vehicle inside images and the vehicle outside images can be displayed on a display device and both images can be recorded.

With regard to this embodiment, FIG. 5 shows the explanatory block diagram for explaining how the components of the vehicle-mounted camera module including an image sensor control section function; the images (the pictures) of the eyes of the driver 52 in the vehicle are formed on the upper area 142 of the image sensor 14 by the light that enters the camera module through the half mirror 12, passes through the inside view optical system 16 and reaches the image sensor 14. On the other hand, the images (the pictures) of the outside views on the vehicle front side are formed on the lower area 144 of the image sensor 14 by the light that enters the camera module through the outside view optical system 18, is reflected by the light reflector 20 and reaches the image sensor 14.

In order to perform the functions of the block diagram of FIG. 5, as per a flow chart such as FIG. 2, an image sensor control section 32 recognizes the images regarding the warning line on the vehicle front side; the image sensor control section 32 detects the situation that the vehicle repeatedly crosses the warning line; the image sensor control section 32 judges that the eyes of the driver 52 cannot be detected from the images formed by the light reaching the image sensor through the inside view optical system 16; then, an alarm issuing section 34 issues an alarm; further, the vehicle speed braking control is performed so that the speed of the vehicle is restrained, while the resistance in turning the steering wheels is increased so that the vehicle is prevented from running in a zigzag line; thus, the precautionary measures against a possible accident are installed. Further, the image sensor control section 32 transfers the data regarding the picked-up images to an image recording section 30 so that the data is stored in video tapes or the memory device of the like in order to provide evidence in case of an accident.

As described above, the vehicle-mounted camera module according to the first embodiment includes no mechanically-moving parts; however, the images regarding the eyes of the driver 52 inside of the vehicle as well as regarding the view of the vehicle outside on the front side can be picked up at the same time; further, the picked-up images can be displayed on display devices or memorized in picture recording devices so that the usefulness of the picked-up images themselves can be enhanced in using the picked-up images for detecting danger or providing evidence in case of an accident.

### Second Embodiment

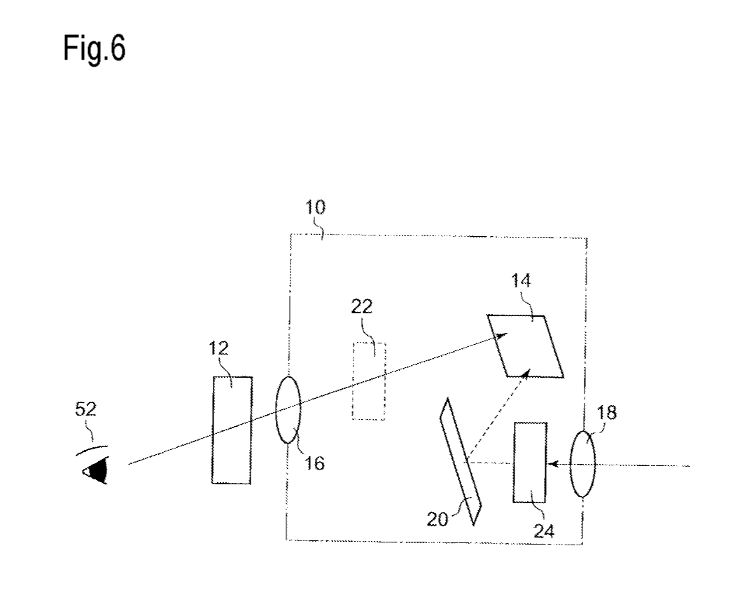

As described above, in the vehicle-mounted camera module according to the first embodiment, the area of the image sensor is divided into the upper area and the lower area so as to pick up the vehicle inside view and the vehicle outside view; thus, the scope that each area of the image sensor can cover is limited to a reduced range; namely, detecting the eyes may be hindered, if the number of the picture elements (pixels) of the image sensor 14 is not sufficiently large; in order to evade such a problem, in a second embodiment, the vehicle-mounted camera module according to the present invention picked up the images of the vehicle inside view and the vehicle outside view in turn in a time-sharing manner, as FIGS. 6, 7(A), 7(B), 8(A) and 8(B) show the second embodiment.

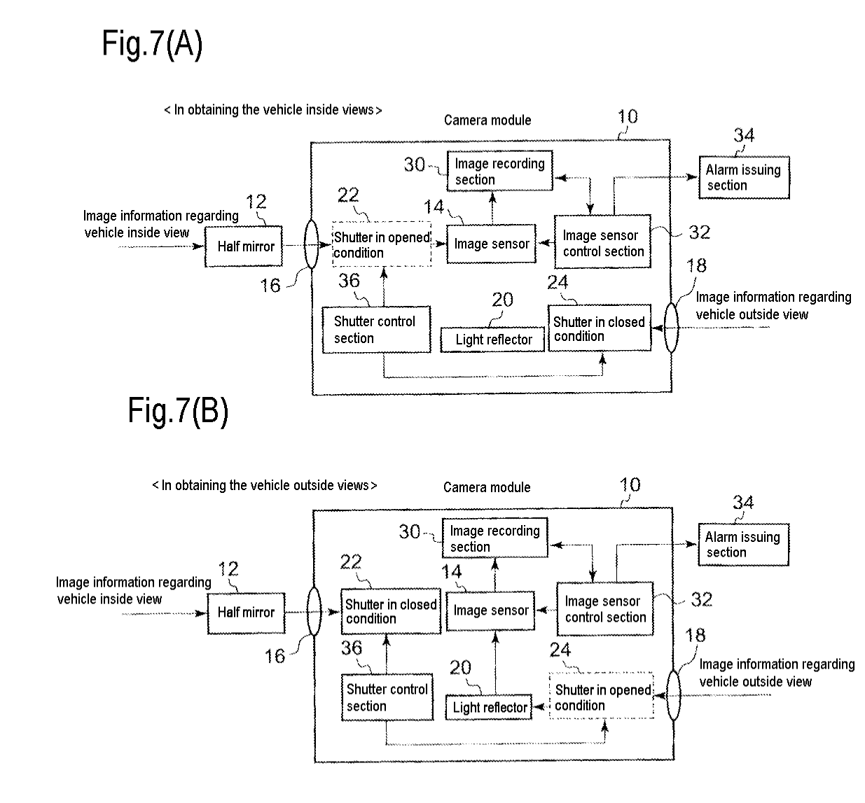

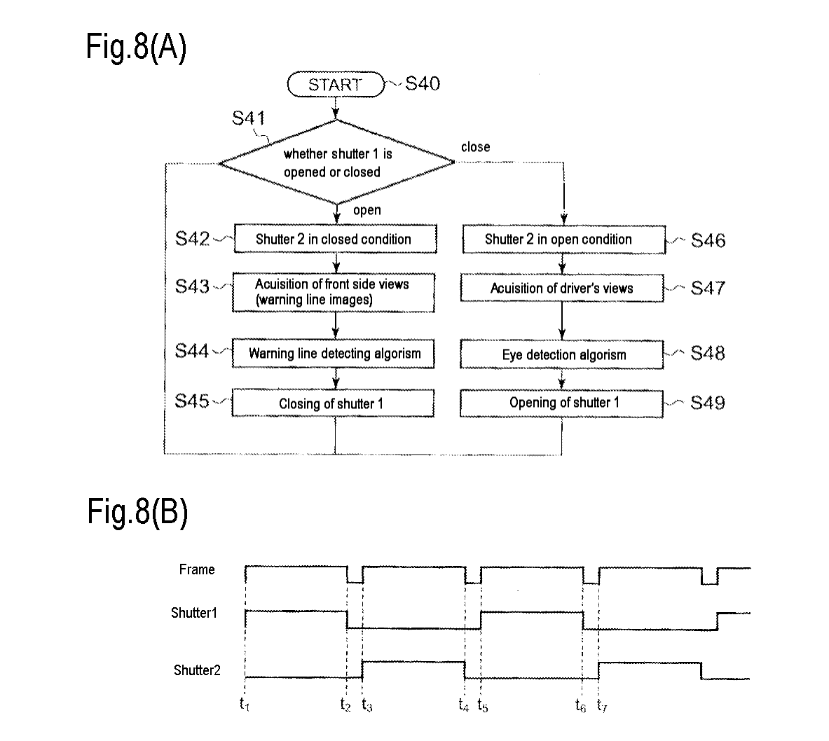

FIG. 6 shows the outline configuration of a second embodiment regarding the vehicle-mounted camera module according to the present invention; FIGS. 7(A) and 7(B) show the explanatory block diagrams regarding the second embodiment whereby the camera module picks up the images of the vehicle inside view and the vehicle outside view in turn; the diagram of FIG. 7(A) is used when the vehicle-mounted camera module picks up the images of the vehicle inside view, and the diagram of FIG. 7(B) is used when the vehicle-mounted camera module picks up the images of the vehicle outside view; FIG. 8(A) shows a flow chart regarding the second embodiment whereby the flow chart is expressed in a time-sharing manner; FIG. 8(B) shows the timing chart in response to FIG. 8(A).

In the vehicle-mounted camera module according to this second embodiment, shutters 22 and 24 are provided in response to the inside view optical system 16 and the outside view optical system 18, respectively, in order to switch the outside view to the inside view and vice versa. More concretely, when the images regarding the eyes of driver 52 are picked up, the shutter 24 of the outside view optical system 18 is closed; and, when the images regarding the road conditions of the vehicle outside are picked up, the shutter 22 of the inside view optical system 16 is closed. Thus, the images regarding the eyes of driver 52 inside of the vehicle as well as the images regarding the road conditions outside of the vehicle are formed on the whole effective image-forming area of the image forming sensor 14, in turn. Hence, the images are formed so as not to be limited to a part of the whole area, whether the images are from the vehicle inside or the vehicle outside.

FIGS. 7(A) and 7(B) show the block diagram that includes an image control section and explains the functional operations in the second embodiment; in FIG. 7(A) where the vehicle-mounted camera module picks up the images of the conditions of the driver inside of the vehicle, the images regarding the eyes of the driver 52 are formed by the light that enters the camera module through the half mirror 12, passes through the inside view optical system 16, passes through the shutter 22 that is opened as per the order from a shutter control section 36 and reaches the image sensor 14; thereby, the shutter 24 on the side of the outside view optical system 18 is closed as per the order from a shutter control section 36. On the other hand, in FIG. 7(B) where the vehicle-mounted camera module picks up the images regarding the outside views on the vehicle front side, the images are formed by the light that enters the camera module through the outside view optical system 18, passes through the shutter 24 that is opened as per the order from the shutter control section 36, is reflected at the light reflector 20 and reaches the image sensor 14; thereby, the shutter 22 on the side of the inside view optical system 16 is closed as per the order from the shutter control section 36.

The flow chart of FIG. 8(A) explains how the components of the vehicle-mounted camera module including an image sensor control section function. At the step S40, a series of processes stars; in the following step S41, it is judged whether or not the shutter 1 (i.e. the shutter 24 in FIG. 6); when the shutter 1 is opened, namely, for example, when the elapsed time is between a time point t₁ and a time point t₂ as shown in FIG. 8(B), then the shutter 1 (i.e. the shutter 24 in FIG. 6) is opened; on the other hand, the shutter 2 (i.e. the shutter 22 in FIG. 6) is closed between the time point t₁ and a time point t₃, and the time interval [t₁, t₃] covers the time interval [t₁, t₂]; thus, the step S41 in FIG. 8(A) is followed by the steps S 42 and S43; in the step S43, the images (regarding warning lines on the road) of the outside on the vehicle front side are picked up; in the following step S44, the warning line is detected as per a warning line detecting algorism such as shown in FIG. 3(A); then, in the step S45, the shutter 1 (i.e. the shutter 24 in FIG. 6) is closed at the time point t₂ as shown in FIG. 8(B).

Further, in the step S41, for example, when the elapsed time is between the time point t₂ and a time point t₅ as shown in FIG. 8(B), then the shutter 1 (i.e. the shutter 24 in FIG. 6) is closed; on the other hand, the shutter 2 (i.e. the shutter 22 in FIG. 6) is opened between the time point t₃ and a time point t₄, and the time interval [t₂, t₅] covers the time interval [t₃, t₄]; thus, the step S41 is followed by the steps 46 and 47; in the step S47, the images regarding the eyes of the driver 52 are picked up; in the following step S48, the eyes are detected as per an eye detecting algorism such as shown in FIG. 3(B); then, in the step S49, the shutter 1 (i.e. the shutter 24 in FIG. 6) is opened at the time point t₅.

As described above, the images of the vehicle inside and the images of the vehicle outside are formed on the image sensor 14 in turn; based on these formed images, as per a flow chart such as FIG. 2, the image sensor control section 32 recognizes the images regarding the warning line on the vehicle front side; the image sensor control section 32 detects the situation that the vehicle repeatedly crosses the warning line; the image sensor control section 32 judges that the eyes of the driver 52 cannot be detected from the images formed by the light reaching the image sensor through the inside view optical system 16; then, the alarm issuing section 34 issues an alarm; further, the vehicle speed braking control is performed so that the speed of the vehicle is restrained, while the resistance in turning the steering wheels is increased so that the vehicle is prevented from running in a zigzag line; thus, the precautionary measures against an accident are installed. Further, the image sensor control section 32 transfers the data regarding the picked-up images to the image recording section 30 so that the data is stored in video tapes or the memory device of the like in order to provide evidence in case of an accident.

As described above, the shutters 22 and 24 are used so that the vehicle-mounted camera module according to the second embodiment can pick up the images regarding the eyes of the driver 52 inside of the vehicle and the images regarding the views of the vehicle outside on the front side, in turn. Thus, when only the shutter 1 is opened, for instance, at a time point (between t1 and t2) as shown in the timing chart of FIG. 8(B), the images of the vehicle outside are formed and can be displayed on a display device; on the contrary, when only the shutter 2 is opened, the images of the vehicle inside are formed and can be displayed on the display device. Further, when the images of the vehicle inside and the images of the vehicle outside are memorized in picture recording devices, then the usefulness of the picked-up images themselves can be enhanced in using the picked-up images for detecting danger or providing evidence in case of an accident.

### Third Embodiment

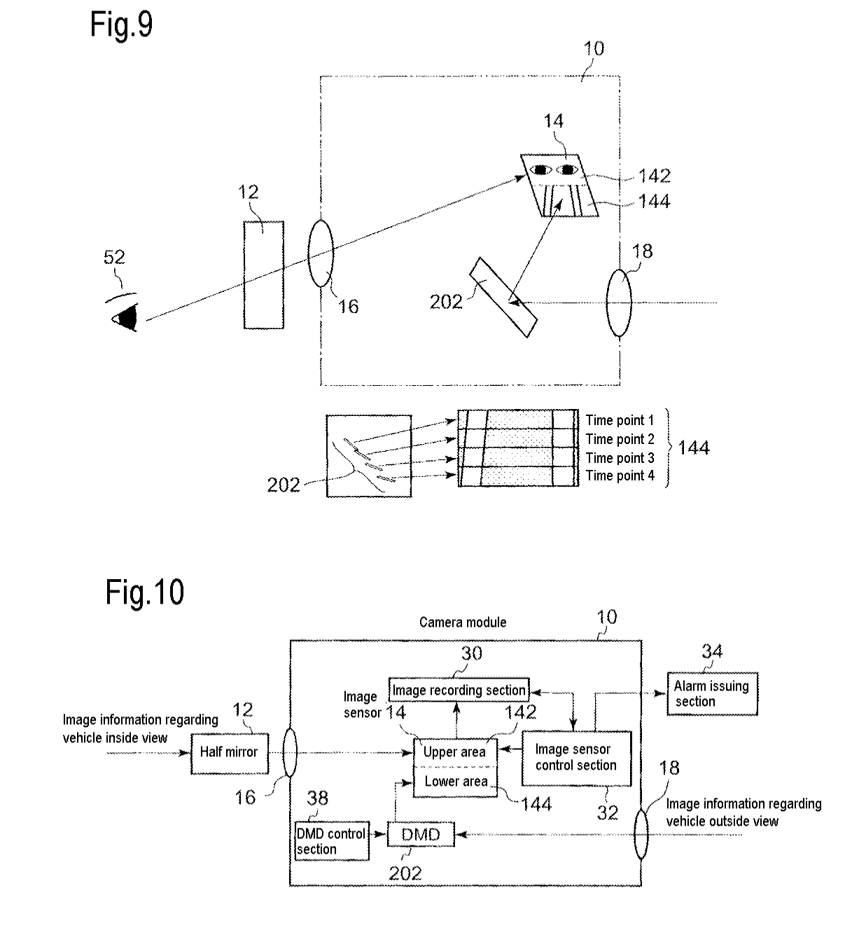

The vehicle-mounted camera module according to the second embodiment as described forms the images of the vehicle inside and the images of the vehicle outside in turn, and copes with the difficulty that the divided areas become small in a case where the whole area of the image sensor 14 is divided as per the first embodiment; on the other hand, the area on which the images regarding the eyes of the driver 52 are formed needs not have so many pixels. Therefore, the camera module has only to cope with the difficulty that the area divided for forming the images of the vehicle outside becomes small. In other words, even in a case where the whole image forming area of the image sensor 14 is divided into the upper area and the lower area as per the first embodiment, no problem happens so long as the camera module can cope with the limited area corresponding to the vehicle outside views. A third embodiment according to the present invention is build on the basis of this concept; FIGS. 9, 10, 11(A) and 11(B) relate to the third embodiment.

FIG. 9 shows the outline configuration of a third embodiment regarding the vehicle-mounted camera module according to the present invention; in this third embodiment, on a part way of the light path from the vehicle outside view to the camera module 14, a light reflector 202 is arranged. The light reflector 202 is configured with a lot of infinitesimal mirrors that form the reflecting surface of the light reflector 202 whereby the reflecting angle of each infinitesimal mirror can be electrically controlled; for instance, the light reflector 202 may be configured with a lot of infinitesimal mirrors of about several micron-meters square, each mirror being arranged on a silicon substrate; further, each mirror can tilt on the silicon substrate by use of electrostatic attraction so that the light rays from the objects that locate at different light-ray angles can reaches different areas on the image sensor 14; for instance, what they call DMD (Digital Micro-mirror Device, or a trademark of Texas Instrument) may be used as the light reflector 202, namely, the controllable light reflecting angle mirror 202.

In the following description, the controllable light reflecting angle mirror 202 is abbreviated to DMD. The DMV 202 is configured with the infinitesimal light-reflecting mirrors that are two dimensionally arrayed; each infinitesimal mirror forms a pixel; each pixel can tilts around an axis along one diagonal line as well as the other axis along the other diagonal line: the tilting angle around each axis covers −10 to +10 degrees; the mirror can tilt within this range of ±10 degrees, like the motion of a seesaw; thus, the direction of the reflected light can be controlled; for instance, in a case where the tilting angle is +10 degrees, the reflecting state is set on an ON condition; and, in a case where the tilting angle is −10 degrees, the reflecting state is set on an OFF condition.

Hence, in the present invention, a plurality of DMDs 20 are arranged in array (a plurality of rows) thereby the light reflecting angle regarding each row can be changed from that regarding other rows; and, by changing the light reflecting angle regarding each DMD element (pixel), the vehicle front side view, namely, the images of the warning lines in this case can be projected on the image sensor one row after another in time series. In this way, even in a case where the whole image forming area of the image sensor 14 is divided into the upper area and the lower area, the images regarding the wide range of vehicle outside view can be obtained. Thus, the camera module can cope with the difficulty that the area divided for forming the images of the vehicle outside becomes small.

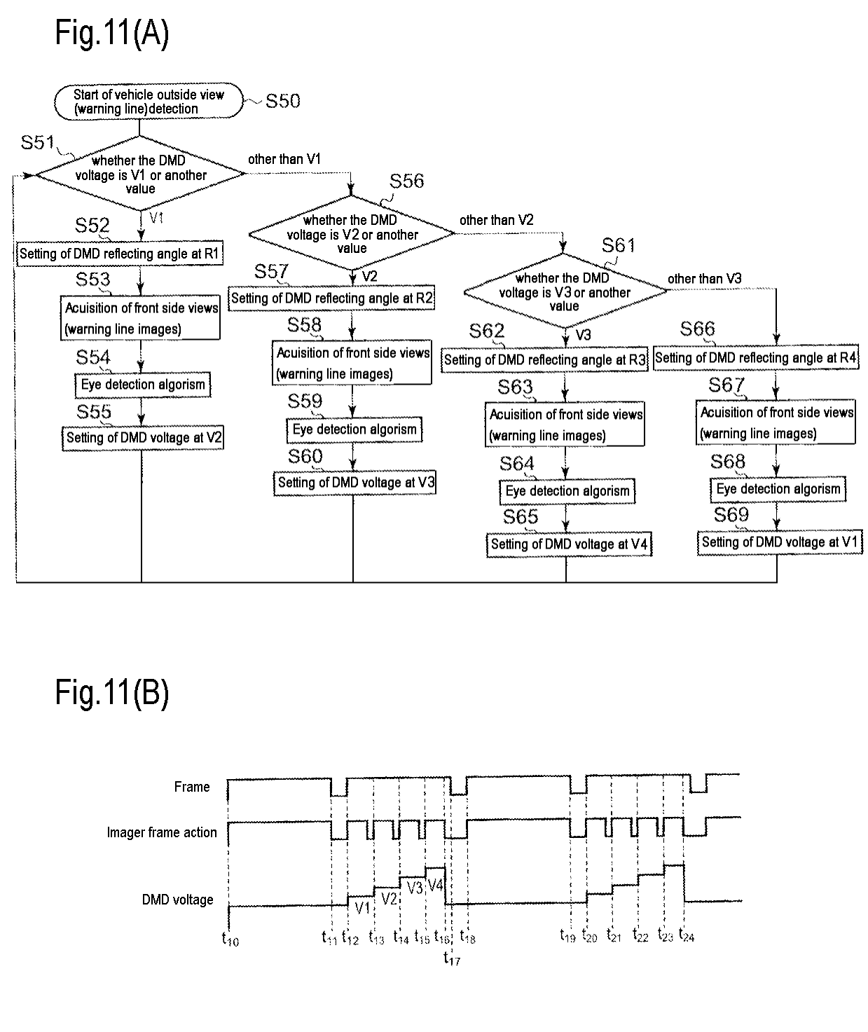

FIG. 10 shows the block diagram regarding the third embodiment of the vehicle-mounted camera module according to the present invention, thereby diagram explains the operations among the components in the vehicle-mounted camera module that includes the control section as a component, in a case where the upper area of the image sensor forms the images of the vehicle inside view and the lower area of the image sensor forms the images of the vehicle outside view in a wide range in chronological order (in time series); FIG. 11(A) shows a flow chart is used in a case where the images of the vehicle outside view in a wide range are formed in chronological order (in time series); and, FIG. 11(B) shows the timing chart in response to FIG. 11(A).

Similar to the explanation regarding FIG. 5, also in the block diagram of FIG. 10, the images (the pictures) of the eyes of the driver 52 in the vehicle are formed on the upper area 142 of the image sensor 14 by the light that enters the camera module through the half mirror 12, passes through the inside view optical system 16 and reaches the image sensor 14. On the other hand, the images (the pictures) of the outside views on the vehicle front side are formed on the lower area 144 of the image sensor 14 by the light that enters the camera module through the outside view optical system 18, is reflected by the DMD 202 and reaches the image sensor 14. Thereby, a DMD control section 38 controls the multiple DMDs 202 so that each DMD is placed in an ON or an OFF state as described above; thus, the images regarding the warning lines on the road of the vehicle front side can be formed in time series as explained with regard to the lower right part of FIG. 9.

Further, FIG. 11(A) explains the flow of the processes regarding the description just above; FIG. 11(B) is the timing chart in response to FIG. 11(A). After a series of processes starts at the step S50 in 11(A), the DMD control section 38 (shown in FIG. 10) sets the applied voltage of the DMD at V1 at a time point t₁₂ (shown in FIG. 11(B)) in the step S51; in the following step S52, the applied voltage is estimated and the value V1 of the voltage is recognized; further, in the step S52, the tilting angle of the DMD is set at a predetermined angle R1 that corresponds to the voltage V1.

In the following step S53, the images in response to the DMD reflecting angle R1 are transferred to the lower area 144 of the image sensor 14; in the following step S54, the warning lines are detected as per the warning line detecting algorism such as shown in FIG. 3(A); then, in the following step S55, the voltage of the DMD is set at V2 at a time point t₁₃ (shown in the time chart of FIG. 11(B)); and, the step S55 is returned back to the step S51.

Thus, when a series of processes returns back to the step S51, the present DMD voltage is kept at V2 that is different from the voltage V1; accordingly, the step S51 is followed by the step S57; further, in the step S57, the tilting angle of the DMD is set at a predetermined angle R2 that corresponds to the voltage V2. Accordingly, the in the following step S58, the images in response to the DMD reflecting angle R2 are transferred to the lower area 144 of the image sensor 14, as is the case with the step S 52 in the flow of the steps S51 to S55. In the following step S59, the warning lines are detected as per the warning line detecting algorism such as shown in FIG. 3(A); then, in the following step S60, the voltage of the DMD is set at V3 at a time point t₁₄ (shown in the time chart of FIG. 11(B)); and, the step S60 is returned back to the step S51.

In a similar way, the processes that follow the flow of steps S61 to S65 as well as the steps S66 to S69 are performed; as shown in the lower left and right parts of FIG. 9, the images regarding the warning lines on the road of the vehicle front side are picked up in chronological order; if it is detected that the vehicle repeatedly crosses the warning line so that the vehicle runs in a zigzag line, as well as, if it is judged that the eyes of the driver 52 cannot be detected from the images formed by the light reaching the image sensor through the inside view optical system 16, then, the alarm issuing section 34 issues an alarm; further, the vehicle speed braking control is performed so that the speed of the vehicle is restrained, while the resistance in turning the steering wheels is increased so that the vehicle is prevented from running in a zigzag line; thus, the precautionary measures against an accident are installed. Further, the image sensor control section 32 transfers the data regarding the picked-up images to the image recording section 30 so that the data is stored in video tapes or the memory device of the like in order to provide evidence in case of an accident.

As described above, in the vehicle-mounted camera module according to the third embodiment, the area of the image sensor 14 is divided into the upper area and the lower area, as is the case with the first embodiment; however, thanks to the multiple DMDs 202, the images of the vehicle outside view in a wide range can be obtained in chronological order; further, the images regarding the eyes of the driver 52 and the images regarding the views of the outside on the vehicle front side are picked up at the same time. In addition, the usefulness of the picked-up images themselves can be enhanced in using the picked-up images for detecting danger or providing evidence in case of an accident.

### Fourth Embodiment

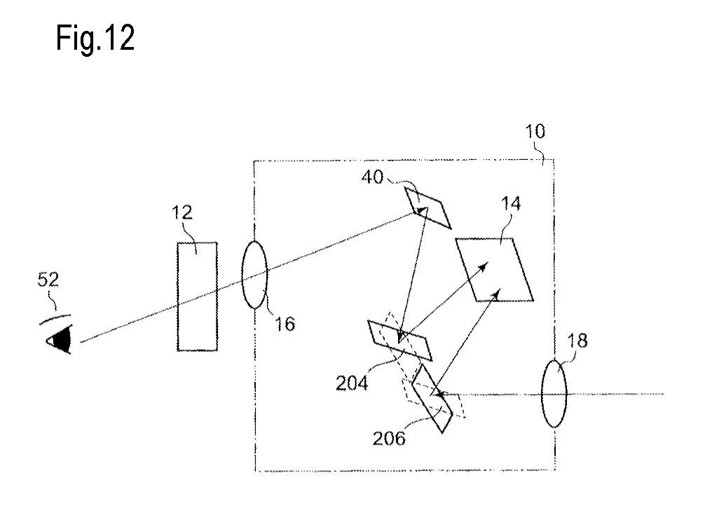

In the third embodiment, applying DMD in the manner as described can cope with the difficulties that the image forming area is limited to a narrow area; further, the DMDs in the third embodiment can be used even for the second embodiment where the images of the vehicle inside and the images of the vehicle outside are picked up in turn in chronological order. In fact, if the DMDs are used instead of the shutters, the images of the vehicle inside and the images of the vehicle outside can be picked up in turn, only by applying voltage on the DMDs. This case is a fourth embodiment of the present invention; FIGS. 12, 13(A), 13(B), and 14 are used for explaining the fourth embodiment.

As shown in FIG. 12, the vehicle-mounted camera module according to this fourth embodiment includes, but not limited to, DMDs 202 and 204, and a light reflector 40; thereby, the light from the driver 52 inside of the vehicle passes through the half mirror 12 and the inside view optical system 16, is reflected by the light reflector 40 and the DMD 204, and reaches the image sensor 14; thus, the images of the driver are formed on the image sensor. On the other hand, the light from the object outside of the vehicle on the vehicle front side passes through the outside view optical system 18, is reflected by the DMD 206, and reaches the image sensor 14; thus, the images of the object outside the vehicle are formed on the image sensor. As is the case with the third embodiment, electric voltage is applied to each of the DMD 204 and 206 in response to the image forming frame (or, clock pulse); thus, the images of the vehicle inside and the views of the vehicle outside are selectively transferred to the image sensor 14 in turn, and the images are formed.

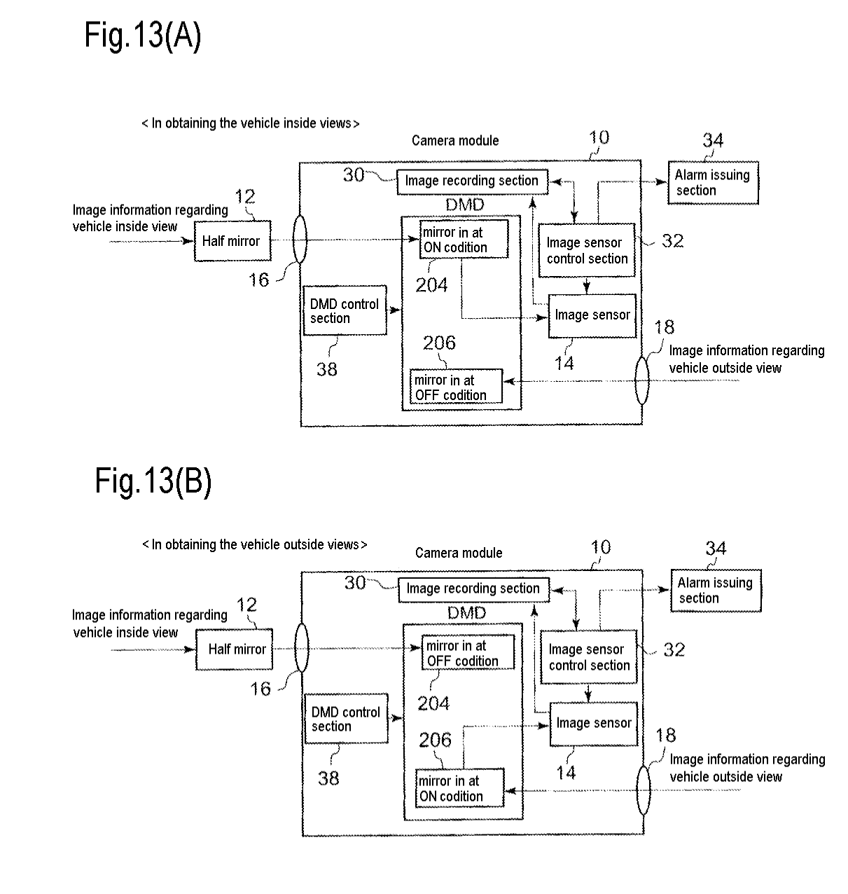

FIGS. 13(A) and 13(B) show the explanatory block diagrams regarding the fourth embodiment of the vehicle-mounted camera module, in a case where the camera module picks up the images of the vehicle inside view and the vehicle outside view in turn in a time-sharing manner, thereby diagram explains the operations among the components in the vehicle-mounted camera module that includes the control section as a component; the diagram of FIG. 13(A) is used when the vehicle-mounted camera module picks up the images of the vehicle inside view, and the diagram of FIG. 13(B) is used when the vehicle-mounted camera module picks up the images of the vehicle outside view. In FIGS. 13(A) and 13(B), the numeral 38 denotes the DMD control section. Firstly, in a case where the vehicle inside views are picked up (namely, in the case of FIG. 13(A)), the DMD control section 38 sets the DMD 204 at an ON state so that the views inside of the vehicle can be picked up. Hence, the light from the driver 52 inside of the vehicle passes through the half mirror 12 and the inside view optical system 16, is reflected by the light reflector 40 and the DMD 204, and reaches the image sensor 14; thus, the images of the driver are formed on the image sensor; thereby, the DMD control section 38 sets the DMD 206 at an OFF state.

On the other hand, in a case where the vehicle outside views are picked up (namely, in the case of FIG. 13(B)), the DMD control section 38 sets the DMD 206 at an ON state as well as the DMD 204 at OFF state so that the views outside of the vehicle can be picked up. Hence the light from the object outside of the vehicle on the front side passes through the outside view optical system 18, is reflected by the DMD 206, and reaches the image sensor 14; thus, the images of the object outside the vehicle are formed on the image sensor.

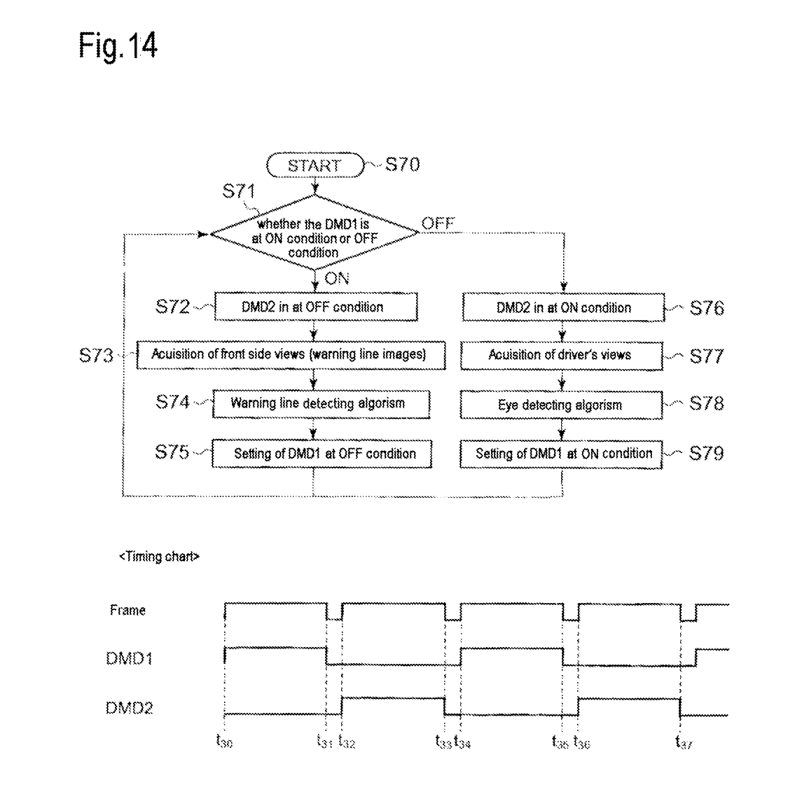

The processes regarding the image forming described above are explained by use of the flow diagram of FIG. 14 (the upper part thereof) and the time chart of FIG. 14 (the lower part thereof). In the flow diagram of FIG. 14 in which a series of steps is followed in chronological order, the process starts at the step S70; in the following step S 71, it is judged whether the DMD1 (i.e. DMD 206) is set at an ON state or an OFF state; when it is judged that the DMD1 is an ON state at a time point t₃₀ as described in the time chart, then the step S71 is followed by the step S72 where the DMD2 (i.e. DMD 204) is set at an OFF state. In the following step S 73, the images regarding the views (the warning lines) outside of the vehicle on the front side are obtained; further, in the following step S74, the warning lines are detected as per the warning line detecting algorism such as shown in FIG. 3(A); then, in the step S75, the DMD1 (i.e. DMD 206) is again set at an OFF state; and, the step S75 returns back to the step S71 where it is judged that the DMD1 is at an OFF state this time. Thus, the step S71 is forwarded to the step S76.

Further, in the step S76, the DMD2 (i.e. DMD 204) is set at an ON state at a time point t₃₂ as described in the time chart of FIG. 14. In the following step S 77, the images regarding the views of the driver is obtained; further, in the following step S78, the eyes of the driver are detected by the eye detecting algorism such as shown in FIG. 3(B); then, in the step S79, the DMD1 (i.e. DMD 206) is again set at an ON state; and, the step S79 returns back to the step S71. In this way, the processes of the flow chart in FIG. 14 are cyclically repeated.

As described above, the images of the vehicle inside and the images of the vehicle outside are formed on the image sensor 14 in turn; thus, the image sensor control section 32 recognizes the images regarding the warning line on the vehicle front side; the image sensor control section 32 detects the situation that the vehicle repeatedly crosses the warning line; the image sensor control section 32 judges that the eyes of the driver 52 cannot be detected from the images formed by the light reaching the image sensor through the inside view optical system 16; then, an alarm issuing section 34 issues an alarm; further, the vehicle speed braking control is performed so that the speed of the vehicle is restrained, while the resistance in turning the steering wheels is increased so that the vehicle is prevented from running in a zigzag line; thus, the precautionary measures against a possible accident are installed. Further, the image sensor control section 32 transfers the data regarding the picked-up images to an image recording section 30 so that the data is stored in video tapes or the memory device of the like in order to provide evidence in case of an accident.

As described above, when the DMDs 204 and 206 are provided, the images regarding the eyes of the driver 52 inside of the vehicle as well as the images regarding the view of the vehicle outside on the front side can be picked up in turn; thus, when only the images that are picked up at time points where the DMD1 (i.e. DMD 206) is set at an ON state as shown in the time chart of FIG. 14 are sent to a display device, then the images of the vehicle outside view can be displayed; on the contrary, when only the images that are picked up at time points where the DMD2 (i.e. DMD 204) is set at an ON state are sent to a display device, then the images of the vehicle inside view can be displayed. Further, when the images of the vehicle outside view as well as the vehicle inside view are recorded in a recording device, the usefulness of the picked-up images themselves can be enhanced in using the picked-up images for detecting danger or providing evidence in case of an accident.

### INDUSTRIAL APPLICABILITY

According to the present invention, it can be realized to provide a useful vehicle-mounted camera module without increasing the cost thereof as well as without introducing complicated image processing steps; thereby, the camera module can be used for detecting the dozing or looking-away motion of the driver based on the conditions regarding the running vehicle as well as regarding the driver inside of the vehicle so that an alarm is issued to prevent an accident; the camera module can be used for detecting the distance between the driver's vehicle and the one ahead as well as detecting the object coming rushing into the driving course of the vehicle so that an alarm is issued to prevent an accident; the camera module can be served as a drive recorder so that the images detected by the camera module can be used as an evidence of the conditions regarding the driver, the vehicle and the road, in case of an accident.

What is claimed is:

1. A vehicle-mounted camera module that is provided inside of the vehicle and surveys views of the inside and outside of the vehicle, the module comprising:
an image sensor;
an inside view optical system for forming images of vehicle inside views on the image sensor;
an outside view optical system for forming images of vehicle outside views of the vehicle front side on the image sensor;
at least one light reflector for reflecting the light that reaches the reflector through at least one of the inside view optical system and the outside view optical system, toward the image sensor.

2. The vehicle-mounted camera module according to claim 1, wherein the image sensor has a first image forming area on which the images are formed by the light passing through the inside view optical system and a second image forming area on which the images are formed by the light passing through the outside view optical system, the two areas including no overlapping area that is common to the two areas.

3. The vehicle-mounted camera module according to claim 1, wherein the inside view optical system has a first shutter and the outside view optical system has a second shutter thereby the first shutter is opened so that images are formed on the image sensor, when the second shutter is closed, whereas the second shutter is opened so that images are formed on the image sensor, when the first shutter is closed, the shutters being operated by a shutter control section provided in the vehicle-mounted camera module.

4. The vehicle-mounted camera module according to claim 1, wherein the light reflector is configured with a plurality of mirrors thereby the light reflecting angle regarding each mirror can be electrically controlled.

5. The vehicle-mounted camera module according to claim 1, the camera module further comprising an abnormal event detecting section that detects an abnormal event based on the vehicle inside image information obtained via the inside view optical system as well as the vehicle outside image information obtained via the outside view optical system, and issues alarm signals.

6. The vehicle-mounted camera module according to claim 1, the camera module further comprising an image recording section that memorizes the image information picked up by the image sensor.

7. The vehicle-mounted camera module according to claim 1, wherein the camera module is installed in the room mirror inside of the vehicle.
